(19) United States
(12) Patent Application Publication
(10) Pub. No.: US 2025/0360876 A1
(43) Pub. Date: Nov. 27, 2025

(54) BLIND SPOT VIEW ENHANCEMENTS FOR VEHICLES

(71) Applicant: Rivian IP Holdings, LLC, Irvine, CA (US)

(72) Inventors: Fai YEUNG, Palo Alto, CA (US); Abhiram KRISHNAN, Surrey (CA); Krishna Kumar MADAPARAMBIL, San Jose, CA (US)

(21) Appl. No.: 19/216,433

(22) Filed: May 22, 2025

Related U.S. Application Data
(60) Provisional application No. 63/651,794, filed on May 24, 2024.

(51) Int. Cl. B60R 1/23; G06T 7/223; G06T 7/277; G06V 10/82; G06V 20/56; G06V 20/58

(52) U.S. Cl. CPC B60R 1/23; G06T 7/223; G06T 7/277; G06V 10/82; G06V 20/58; G06V 20/588; B60R 2300/105; B60R 2300/301; B60R 2300/302; B60R 2300/802; B60R 2300/8093; G06T 2207/10016

(57) ABSTRACT

Systems and methods for vehicle blind spot object tracking are provided. Embodiments include performing object detection using a machine learning model based on video data captured by one or more cameras associated with a vehicle in order to detect an object, predicting an intent associated with the object based on one or more features associated with the object in the video data, applying a collision prediction algorithm based on the object, the intent associated with the object, and one or more measured attributes of the vehicle, in order to predict a proximity between the vehicle and the object in a given direction, and generating, after determining an intent to move the vehicle in the given direction, an alert for presentation within the vehicle based on the predicted proximity between the vehicle and the object.

### RELATED APPLICATION

This application claims the benefit of U.S. Provisional Application Ser. No. 63/651,794 filed May 24, 2024, and entitled BLIND SPOT VIEW ENHANCEMENTS FOR VEHICLES.

### INTRODUCTION

The present disclosure relates to vehicles. More particularly, the present disclosure relates to blind spot view enhancements for vehicles.

### SUMMARY

Embodiments of the present disclosure advantageously provide systems and methods for blind spot view enhancements for vehicles.

In certain embodiments, a method for blind spot object tracking may include performing object detection using a machine learning model based on video data captured by one or more cameras associated with a vehicle in order to detect an object, predicting an intent associated with the object based on one or more features associated with the object in the video data, applying a collision prediction algorithm based on the object, the intent associated with the object, and one or more measured attributes of the vehicle, in order to predict a proximity between the vehicle and the object in a given direction, and generating, after determining an intent to move the vehicle in the given direction, an alert for presentation within the vehicle based on the predicted proximity between the vehicle and the object.

### BRIEF DESCRIPTION OF THE DRAWINGS

FIG. 1A and FIG. 1B depict diagrams of an example vehicle, in accordance with embodiments of the present disclosure.

FIG. 2 presents a block diagram of example components of a vehicle, in accordance with embodiments of the present disclosure.

FIG. 3 depicts a flow chart representing functionality associated with blind spot object tracking, in accordance with embodiments of the present disclosure.

FIG. 4 depicts another flow chart representing functionality associated with blind spot object tracking, in accordance with embodiments of the present disclosure.

FIG. 5 depicts another flow chart representing functionality associated with blind spot object tracking, in accordance with embodiments of the present disclosure.

FIG. 6 depicts another flow chart representing functionality associated with blind spot object tracking, in accordance with embodiments of the present disclosure.

FIG. 7 depicts an example display screen associated with blind spot object tracking, in accordance with embodiments of the present disclosure.

FIG. 8 depicts another example display screen associated with blind spot object tracking, in accordance with embodiments of the present disclosure.

### DETAILED DESCRIPTION

Vehicles may provide object tracking and alert capability, such as to assist drivers with identifying and avoiding objects on or near the road, such as other vehicles, pedestrians, cyclists, animals, and/or the like. In some cases, a vehicle may provide such functionality in particular for a driver's “blind spots,” such as regions in or near the rear left side and rear right side of the vehicle.

According to techniques described herein, enhanced blind spot object tracking may be performed through the use of machine learning and/or other predictive algorithms that enable a blind spot object detection system to consider not only the current position of the vehicle and one or more detected external objects, but also predicted future positions of the vehicle and the one or more detected external objects. Through such predictive capability, aspects of the present disclosure enable an intelligent, dynamic, and proactive blind spot monitoring process such that alerts and/or other guidance related to detected objects may be generated for presentation to a driver of a vehicle when, or even before, the driver signals an intent to move the vehicle in a given direction (e.g., change lanes).

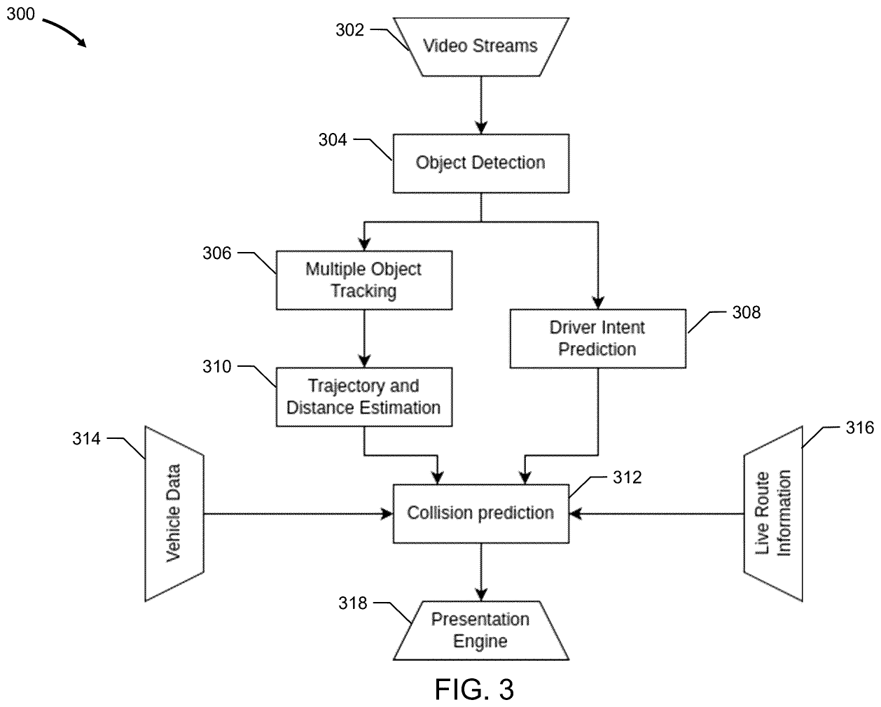

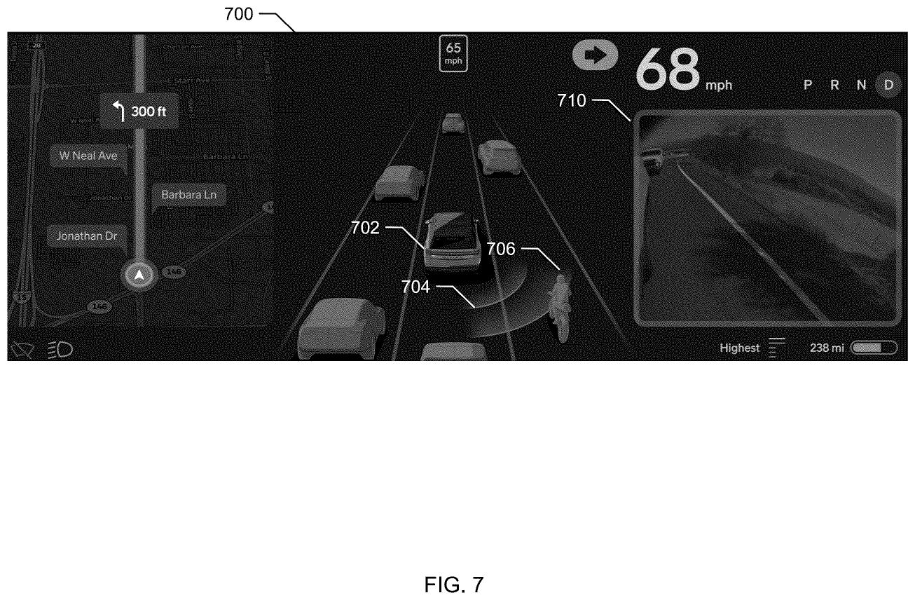

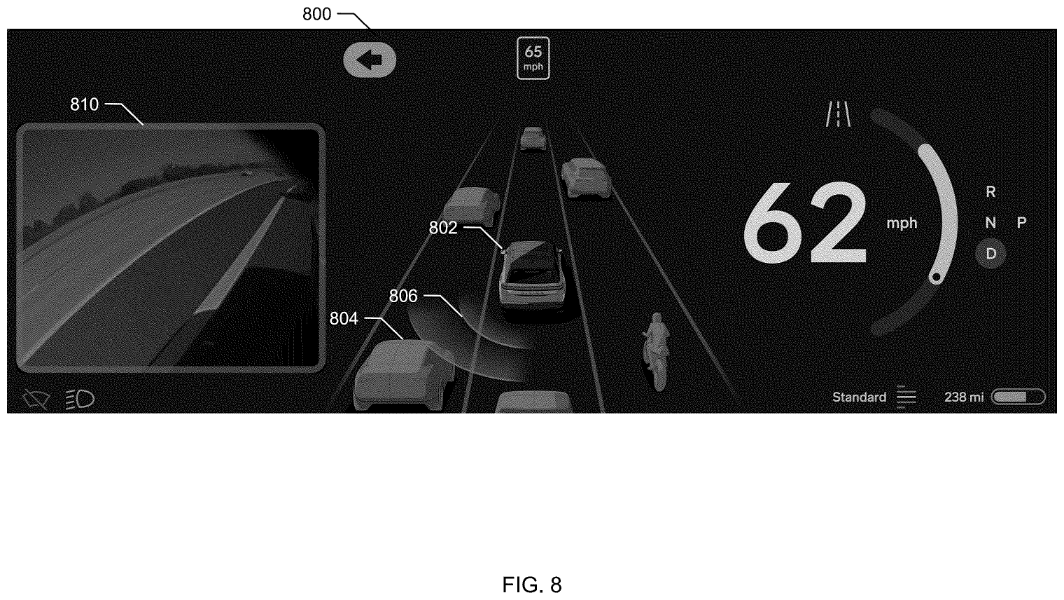

In some embodiments, as described in more detail below with respect to FIG. 3, video streams captured via a left side camera and/or a right side camera of a vehicle may be analyzed using a machine learning model that has been trained for object detection. Objects detected using such a machine learning model may then be tracked using a multiple object tracking (MOT) algorithm to estimate distances and trajectories of the objects. Furthermore, intents associated with detected objects may be predicted using a predictive algorithm, such as to predict whether the objects are likely to move in a particular direction, move at a particular speed, be in a particular location at a particular time, and/or the like. Additionally, data about the vehicle, such as the vehicle's speed and/or route data (e.g., associated with a satellite based navigation system), may be analyzed to predict whether the vehicle is likely to move in a particular direction, move at a particular speed, be in a particular location at a particular time, and/or the like. These predictions about the vehicle and detected object(s) may be used by a collision prediction engine to determine whether the vehicle and a detected object are likely to be located in close proximity to one another in a given direction, and such a proximity prediction may be used to generate an alert for presentation within the vehicle. An alert may, for example, comprise a display of a camera view on an instrument cluster screen and/or using color, outlines of objects, visual indicators, text, sound, tactile feedback, and/or the like to provide the driver with information relevant to operation of the vehicle, such as potential lane changes. Examples, of such an alert are described below with respect to FIGS. 7 and 8.

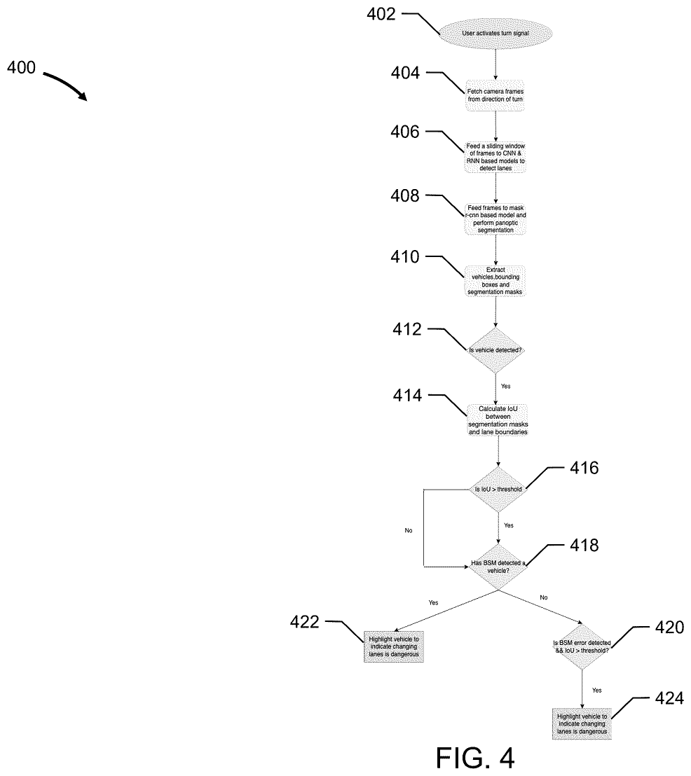

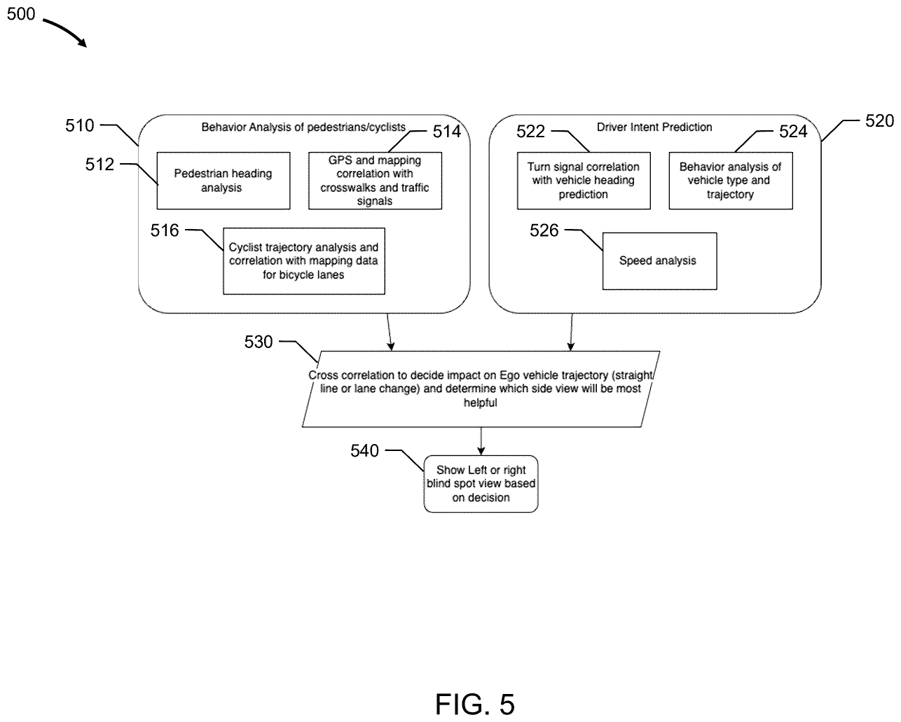

In some aspects, as described in more detail below with respect to FIG. 4, lane-specific location predictions may be generated based on performing panoptic segmentation of images captured using vehicle cameras to detect lane boundaries and comparing the detected lane boundaries to segmentation masks associated with detected objects in the images. Such lane-specific predictions may be used in combination with other blind spot object tracking techniques to generate alerts as appropriate. Furthermore, as described in more detail below with respect to FIG. 5, in some embodiments, images from one or more cameras, such as a rear-facing camera of the vehicle, may be used to proactively predict proximity between the vehicle and a detected object, such as to present a blind spot alert to the driver prior to the driver signaling an intent to change lanes (e.g., by activating a turn signal) in a particular direction.

Predictive functionality, object tracking, and preemptive monitoring techniques described herein enable improved contextual awareness and sophisticated early warning capabilities, allowing a driver of a vehicle to be provided with timely alerts about potential proximity of objects, particularly in the driver's blind spots.

While embodiments of the present disclosure are presented with respect to an electric vehicle, the present disclosure is not limited to electric vehicles and may be incorporated into any combustion engine vehicle.

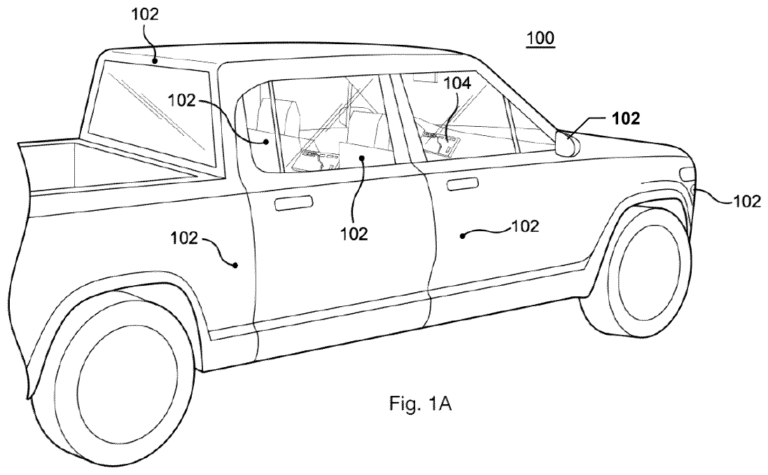

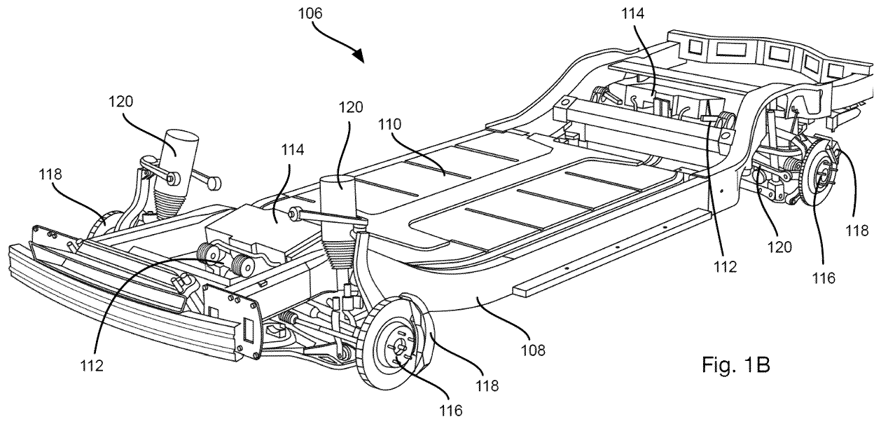

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

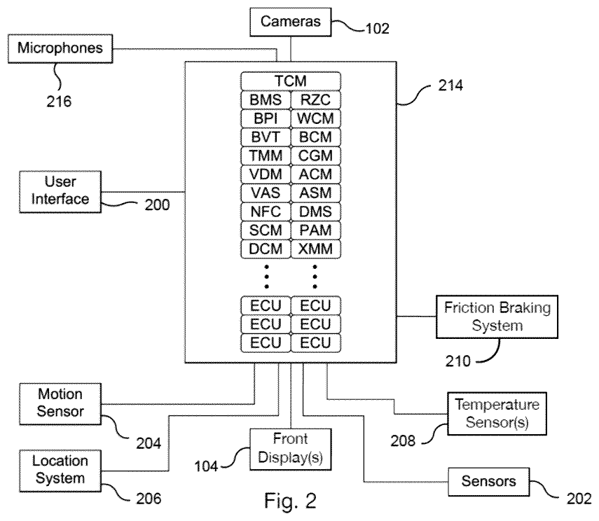

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below in relation to FIGS. 3 to 6.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfers data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described in relation to FIGS. 3 to 6.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

FIG. 3 depicts a flow chart 300 representing functionality associated with blind spot object tracking, in accordance with embodiments of the present disclosure.

In certain embodiments, video streams 302 represent video data (e.g., comprising one or more series of images) captured via one or more of cameras 102 of FIGS. 1A and 2. For example, video streams 302 may comprise video data captured via a left side camera 102 and a right side camera 102 of vehicle 100 of FIGS. 1A-2.

Object detection 304 may be performed on video streams 302 in order to detect one or more objects present in video streams 302. For example, object detection 304 may involve the use of a machine learning model that has been trained for object detection. In one embodiment, object detection 304 involves the use of the YOLOv8 object detection model from Ultralytics®. In other embodiments, any suitable object detection model, such as a neural network (e.g., deep learning model) trained for computer vision tasks, may be used at object detection 304. In one example, object detection 304 involves providing images from video streams 302 as inputs to a machine learning model and receiving, as outputs from the machine learning model in response to the inputs, an indication of one or more objects present in one or more of the images, such as bounding boxes and/or class labels of such one or more objects.

One or more objects detected at object detection 304 may be tracked at multiple object tracking (MOT) 306. For example, MOT 306 may involve performing a simple online real-time tracking (SORT) or DeepSORT algorithm, or another suitable MOT algorithm. MOT 306 generally involves keeping track of one or more detected objects over time. For example, MOT 306 may accept a list of detected objects associated with confidence scores and bounding boxes output by object detection 304, and may output information about all current “tracks” such as identifiers of unique objects that are detected across multiple image frames such that the progress of each unique object is tracked in association with an assigned identifier across multiple image frames. At trajectory and distance estimation 310, signal from corner radar sensors of the vehicle (e.g., one or more of sensors 202 of FIG. 2) may be fused together with the camera input (e.g., represented by an output of MOT 306, which is based on video streams 302) to produce distance and trajectory vectors for each of the detected objects. For example, a distance vector for a tracked object that is output by trajectory and distance estimation 310 may indicate an estimated distance between the tracked object and the vehicle, and a trajectory vector output for a tracked object that is output by trajectory and distance estimation 310 may indicate an estimated trajectory of the tracked object.

An intent related to objects detected at object detection 304 may be predicted at driver intent prediction 308. For example, driver intent prediction 308 may involve analyzing visual signals associated with one or more objects detected at object detection 304, such as turn signals, emergency flashers, object pose, and/or the like, to predict where a given object (e.g., vehicle, cyclist, pedestrian, animal, and/or the like) is likely to move and when such movement is likely to occur. For example, driver intent prediction 308 may involve the use of a machine learning model such as a computer vision model, time series model, barrier function, deep learning model, and/or the like, and such a machine learning model may output an indication of an intent associated with a given detected object (e.g., whether the object is likely to move into a particular lane, speed up, slow down, turn, and/or the like), such as based on visual indicators present in images of the detected object and/or based on position, speed, heading, and/or one or more other detected attributes related to the detected object. It is noted that while the term “driver intent” is used, driver intent prediction 308 may also involve predicting intent of objects that are not necessarily vehicles controlled by a driver, such as pedestrians, animals, autonomous vehicles, and/or the like.

At collision prediction 312, outputs of trajectory and distance estimation 310 and/or driver intent prediction 308 may be used along with information related to the vehicle (e.g., vehicle data 314 and live route information 316) to determine a likelihood of a proximity occurring between the vehicle and each detected object, such as in a given direction. Vehicle data 314 may, for example, include speed, steering wheel angle, acceleration, heading, and/or the like for the vehicle (e.g., which may be captured via one or more sensors associated with the vehicle, such as one or more of sensors 202 of FIG. 2). Live route information 316 may, for example, include information about a route of the vehicle, such as from a satellite based navigation system associated with the vehicle, such as location system 206 of FIG. 2 (e.g., the route may be based on input from the driver, such as configuring a destination to which the vehicle is headed via user interface 200 of FIG. 2, and based on a detected position of the vehicle relative to the route). Collision prediction 312 may involve logic and/or one or more machine learning models that may be used to analyze outputs from trajectory and distance estimation 310, driver intent prediction 308, vehicle data 314, and live route information 316 in order to predict whether a detected object is now or is likely to be (e.g., at a given time) located within a given distance of the vehicle in a given direction. For example, collision prediction 312 may involve predicting whether a collision or near-collision between the vehicle and a detected object is likely to occur if the vehicle were to move into a particular lane within a given amount of time. In some embodiments, collision prediction 312 is based on the use of optical flow, block matching, and/or Kalman filtering technique(s) with respect to the video data to monitor movement of a detected object (e.g., at MOT 306, trajectory and distance estimation 310, and/or at collision prediction 312).

A presentation engine 318 may generate one or more alerts for presentation within the vehicle based on output from collision prediction 312. For example, presentation engine 318 may generate an alert indicating a predicted proximity (or potential for collision) between the vehicle and a given detected object in a given direction. Such an alert may be provided to the user in the form of a blind spot view within user interface 200 of FIG. 2, such as displayed on an instrument panel within the vehicle. For example, a live view from a side camera of the vehicle in a direction in which the driver has signaled an intent to move (or in which the driver has been predicted to move) may be displayed within the vehicle. In some embodiments, one or more detected objects that are predicted to be of interest (e.g., due to a proximity and/or likelihood of collision) may be highlighted (e.g., in a particular color, such as applied to a bounding box of a given object) and/or otherwise indicated within the display, such as within the live camera view. In one example, a bounding box of a detected object is overlaid, such as in a given color (e.g., red) and/or having other characteristics (e.g., blinking), onto the live camera view that is displayed to the user to bring the object to the driver's attention. In other examples, alerts may involve the use of color, text, graphics, visual indicators, sound, tactile feedback, and/or the like. Examples of such alerts are described below with respect to FIGS. 7 and 8.

It is noted that the process described with respect to flow chart 300 may be performed on an ongoing basis, at regular intervals, and/or when one or more conditions occur (e.g., when an intention to change lanes or turn is predicted for the vehicle), and not necessarily only when a driver of the vehicle activates a turn signal in a given direction. For instance, vehicle data 314 and/or live route information 316 may be used to predict whether a driver of the vehicle is likely to change lanes or turn even if the driver has not yet activated a turn signal. Thus, in some embodiments, an alert may be presented to the driver proactively, such as before the driver activates a turn signal, immediately after the driver activates a turn signal, and/or immediately after a potential proximity or possibility of collision is predicted.

FIG. 4 depicts another flow chart 400 representing functionality associated with blind spot object tracking, in accordance with embodiments of the present disclosure. For example, the functionality described with respect to flow chart 400 may be performed in conjunction with or independently of functionality described above with respect to flow chart 300 of FIG. 3 in order to determine whether to generate an alert related to a detected object.

In certain embodiments, functionality associated with blind spot object tracking may include functional blocks 402, 404, 406, 408, 410, 412, 414, 416, 418, 420, 422, and 424. In other embodiments, these functional blocks may be arranged in a different order, certain functional blocks may be omitted, other functional blocks may be added, etc.

At 402, a user (e.g., driver) may activate a turn signal. For example, the driver may activate a left or right turn signal. Alternatively, a driver intent to change lanes or turn may be predicted (e.g., based on vehicle data and/or route data).

At 404, camera frames from a direction associated with the turn signal may be fetched. For example, image frames from one or more cameras (e.g., cameras 102 of FIG. 1A) on a side of the vehicle corresponding to a direction of the turn signal that was activated are retrieved.

At 406, a sliding window of frames (e.g., the camera frames fetched at 404) may be fed to a convolutional neural network (CNN) based model and/or a recurrent neural network (RNN) based model in order to detect one or more lanes. For example, an ensemble model comprising a CNN and an RNN may have been trained through a supervised learning process to output an indication of one or more lanes (e.g., a bounding box of each detected lane) in response to being provided with a sliding window of camera frames (e.g., captured via one or more cameras 102 of FIG. 1A). A CNN may be used for detection of objects (e.g., lanes) in the image frames and an RNN may be used for sequential analysis of detected objects across multiple sequential image frames.

At 408, the frames (e.g., the camera frames fetched at 404) may be fed to a region-based CNN (R-CNN) model, such as a mask R-CNN in order to perform panoptic segmentation. An R-CNN is generally trained to perform a two-step object detection process that involves identifying regions in an image that may contain an object and classifying objects based on features extracted from the regions. A mask R-CNN extends the concept of an R-CNN by detecting objects in an image while simultaneously generating a high-quality segmentation mask for each instance, such as including a branch for predicting an object mask in parallel with the existing branch (that is present in a standard R-CNN) for bounding box recognition. Panoptic segmentation involves identifying the class (e.g., trackable objects like cars or people may be one class, while non-trackable objects like the sky or pavement may be another class) each pixel in an image belongs to while distinguishing between different instances of the same class. For example, panoptic segmentation may be based on an output from an R-CNN such as a mask R-CNN, such as using one or more object bounding boxes and/or segmentation masks determined by such a model to determine whether each pixel belongs to one class or another.

At 410, vehicles (and/or other objects), bounding boxes, and segmentation masks are extracted. For example, the results of analyzing the camera frames using an R-CNN such as a mask R-CNN and/or performing panoptic segmentation at 408 may be used to identify one or more vehicles (and/or other objects), bounding boxes, and segmentation masks from the camera frames.

At 412, a determination is made of whether a vehicle is detected. For example, if results of 408, and/or 410 indicate that a vehicle (and/or other object) is detected in one or more camera frames, then operations may proceed to 414, where an intersection over union (IoU) between segmentation masks and lane boundaries is calculated. If results of 408, and/or 410 indicate that a vehicle (and/or other object) is not detected in one or more camera frames, then the process may end (or return to 402 and/or another functional block or process).

At 414, an IoU between segmentation masks (e.g., extracted at 408 and/or 410) and lane boundaries (e.g., detected at 406) is calculated. IoU is a measure of overlap between two boxes or regions, such that a higher amount of overlap results is a higher IoU value and a lower amount of overlap results in a lower IoU value. Generally, the IoU between two boxes equals the area of intersection between two boxes divided by the area of union of the two boxes.

At 416, a determination is made of whether the IoU calculated at 414 exceeds a threshold. For example, the threshold may be a configurable value, and may represent a value above which an IoU between a bounding box of a detected object and a lane boundary is likely to indicate that the detected object is within the lane represented by the lane boundary.

At 418, a determination is made of whether a blind spot monitoring (BSM) process (e.g., the process described above with respect to flow chart 300 of FIG. 3 and/or another similar process) detected a vehicle (and/or another object). If the IoU exceeds the threshold at 416 and the BSM process detected a vehicle or other object at 418, then operations proceed to 422, where an alert is generated, such as highlighting the vehicle or other object (e.g., in a live camera view displayed within the vehicle) and/or otherwise providing the driver with an indication that changing lanes may be dangerous and/or bringing the detected vehicle or other object to the driver's attention. Operations may also proceed to 422 based on some other combination of the results of 416 and 418, such as if the IoU exceeds a threshold and BSM did not detect a vehicle or if BSM detected a vehicle and IoU does not exceed the threshold.

If a determination is made at 418 that BSM did not detect a vehicle, operations may proceed to 420, where a determination is made of whether a BSM error is detected and the IoU exceeds the threshold (e.g., at 416). If both conditions are true at 420, then operations may proceed to 424, where an alert is generated, such as highlighting the vehicle or other object (e.g., in a live camera view displayed within the vehicle) and/or otherwise providing the driver with an indication that changing lanes may be dangerous and/or bringing the detected vehicle or other object to the driver's attention. A BSM error may be detected if, for example, the BSM process returns an error condition, if the IoU exceeds a given threshold (e.g., indicating a high level of confidence) while the BSM indicates no object is detected, and/or the like.

In some cases, no alert may be generated if IoU does not exceed the threshold and/or if BSM did not detect a vehicle or other object, and/or if some level of confidence associated with one or both determinations does not exceed a threshold. It should be understood that various techniques are possible for utilizing the results of comparing IoU to a threshold and determining whether BSM detected a vehicle or other object for determining whether to generate an alert. More generally, according to certain embodiments, a BSM process such as that described above with respect to FIG. 3 and a calculated IoU between segmentation masks and lane boundaries as described with respect to FIG. 4 may be used to determine whether to generate alerts related to detected objects.

FIG. 5 depicts another flow chart 500 representing functionality associated with blind spot object tracking, in accordance with embodiments of the present disclosure. For example, flow chart 500 may represent functionality that is performed in combination with and/or independently of functionality described above with respect to FIGS. 3 and 4, such as using video data captured using one or more rear-facing cameras of a vehicle (e.g., one of cameras 102 of FIG. 1A).

At behavior analysis of pedestrians/cyclists 510, functionality related to analyzing behavior of objects such as pedestrians and/or cyclists may be performed. For example, pedestrian heading analysis 512 may involve determining headings of one or more pedestrians and/or cyclists detected in camera frames captured via a rear-facing camera of the vehicle (e.g., based on use of one or more object detection machine learning models, such as a model described above with respect to FIG. 3 or 4). Global positioning system (GPS) and mapping correlation with crosswalks and traffic signals 514 may involve correlating route and/or other location/mapping/GPS data (e.g., indicating the presence of crosswalks and/or traffic signals) with objects such as pedestrians detected in camera frames (e.g., based on use of one or more object detection machine learning models, such as a model described above with respect to FIG. 3 or 4), such as to determine the presence and/or location(s) of one or more crosswalks and/or traffic signals relative to one or more objects, such as pedestrians. Cyclist trajectory analysis and correlation with mapping data for bicycle lanes 516 may involve analyzing the trajectories of one or more cyclists detected in camera frames (e.g., based on use of one or more object detection machine learning models, such as a model described above with respect to FIG. 3 or 4) and determining whether such trajectories correspond to location/mapping/GPS data indicating the presence and/or location(s) of one or more bicycle lanes.

More generally, behavior analysis of pedestrians/cyclists 510 may involve determining where objects such as pedestrians and/or cyclists are likely to move and/or when such movement is likely to occur, relative to the vehicle and/or relative to crosswalks, traffic signals, and/or bicycle lanes, based on object detection/tracking in images and/or based on location/GPS/mapping data.

At driver intent prediction 520, functionality related to analyzing behavior of objects such as vehicles in order to predict intents of drivers of the vehicles may be performed. For example, turn signal correlation with vehicle heading prediction 522 may involve correlating turn signals on vehicles that are detected in camera frames (e.g., based on use of one or more object detection machine learning models, such as a model described above with respect to FIG. 3 or 4) with predicted headings of the vehicles, such as to determine if predicted headings are consistent with detected turn signals. Behavior analysis of vehicle type and trajectory 524 may involve analyzing behavior of vehicles detected in camera frames (e.g., based on use of one or more object detection machine learning models, such as a model described above with respect to FIG. 3 or 4) based on detected types of the vehicle (e.g., delivery vehicle, mail vehicle, taxi or rideshare vehicle, emergency vehicle, and/or the like) and trajectories of the vehicles, such as to determine where vehicles are likely to move and/or when such movement is likely to occur based on trajectories and expected behavior associated with particular vehicle types. Speed analysis 526 may involve analyzing detected speeds of vehicles detected in camera frames (e.g., based on use of one or more object detection machine learning models, such as a model described above with respect to FIG. 3 or 4), such as determining how fast a detected vehicle is moving based on its position across multiple camera frames and/or based on other information such as radar information captured via one or more sensors associated with the vehicle.

More generally, driver intent prediction 520 may involve determining where vehicles detected in camera frames are likely to move and/or when such movement is likely to occur, relative to the vehicle, based on object detection/tracking in images (e.g., detecting the vehicles as well as attributes of the vehicles such as turn signals, headings, trajectories, vehicle types and/or the like) and/or based on data captured using other sensors.

At cross correlation to decide impact on ego vehicle trajectory (straight line or lane change) and determine which side view will be most helpful 530, the results of behavior analysis of pedestrians/cyclists 510 and driver intent prediction 520 may be correlated with the vehicle's trajectory (and/or where the vehicle is predicted to move, such as based on vehicle data and/or route data, as discussed above). A determination may be made of whether any detected object (e.g., pedestrian, cyclist, vehicle, or the like) is likely to be located in or near a location that the vehicle is likely to move to (e.g., in a given direction), and such a determination may be used to determine if displaying either the left side camera view or the right side camera view to the driver is likely to be helpful. For example, if the vehicle is predicted to move one lane to the right in the near future, and a detected vehicle has been predicted (e.g., at driver intent prediction 520) to be located within a given distance of a location in the adjacent lane to the right of the vehicle that the vehicle is likely to move into, then the right side camera view may be displayed within the vehicle proactively (e.g., via a user interface 200 of FIG. 2 and/or on an instrument panel), such as before the driver activates a right turn signal.

At show left or right blind spot view based on decision 540, a left camera view or right camera view (e.g., a live feed from a left-facing camera or a right-facing camera) may be displayed within the vehicle, such as to alert the driver to the presence of an object in the driver's blind spot. As discussed above, an alert may include the use of overlays, color, text, visual indicators, blinking visual content, audio, tactile feedback, and/or the like to alert the driver to the presence of a detected object that is predicted to be located in or near (e.g., within a threshold distance of) a location to which the vehicle is predicted to move. Examples of such alerts are described below with respect to FIGS. 7 and 8.

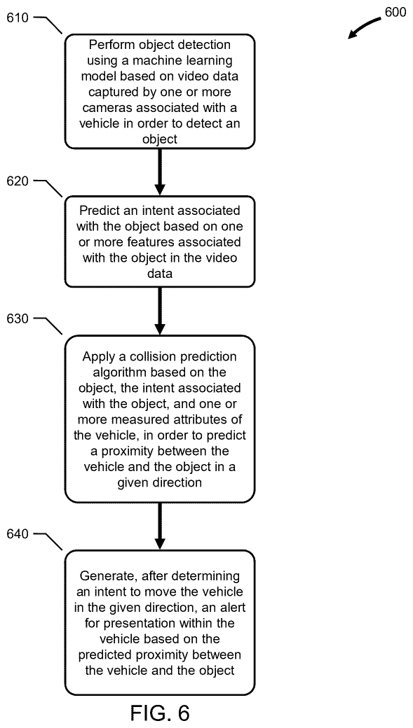

FIG. 6 depicts a method 600 representing functionality associated with blind spot object tracking, in accordance with embodiments of the present disclosure. For example, method 600 may be performed by one or more components of the vehicle 100 of FIG. 1A, such as one or more ECUs of control system 214 of FIG. 2.

The method 600 may include performing, at 610, object detection using a machine learning model based on video data captured by one or more cameras associated with a vehicle in order to detect an object.

The method 600 may include predicting, at 620, an intent associated with the object based on one or more features associated with the object in the video data.

The method 600 may include applying, at 630, a collision prediction algorithm based on the object, the intent associated with the object, and one or more measured attributes of the vehicle, in order to predict a proximity between the vehicle and the object in a given direction.

The method 600 may include generating, at 640, after determining an intent to move the vehicle in the given direction, an alert for presentation within the vehicle based on the predicted proximity between the vehicle and the object.

In certain embodiments, the applying of the collision prediction algorithm is further based on route data for the vehicle, and the route data for the vehicle is based on a configured route associated with a satellite-based navigation system.

Some embodiments further comprise estimating a distance and a trajectory associated with the object relative to the vehicle based on performing multiple object tracking (MOT) using a computer vision technique after the detecting of the object, wherein the applying of the collision prediction algorithm is based on the distance and the trajectory.

In certain embodiments, the one or more measured attributes comprise one or more of a speed of the vehicle, a steering wheel angle of the vehicle, or a heading of the vehicle.

In some embodiments, the applying of the collision prediction algorithm is further based on performing an optical flow, block matching, or Kalman filtering technique with respect to the video data to monitor movement of the object.

Some embodiments further comprise providing a sliding window of frames from the video data as inputs to a convolutional neural network (CNN) and a recurrent neural network (RNN) to detect one or more traffic lanes, extracting a segmentation mask of the object from the frames, and comparing boundaries of the one or more traffic lanes to the segmentation mask of the object to predict whether the object is in an adjacent lane to the vehicle, wherein the generating of the alert is further based on the predicting of whether the object is in the adjacent lane to the vehicle.

In certain embodiments, the comparing of the boundaries of the one or more traffic lanes to the segmentation mask of the object comprises computing an intersection over union (IoU) of the boundaries of the one or more traffic lanes to the segmentation mask of the object and comparing the IoU to a threshold.

Some embodiments further comprise analyzing data captured using a rear-facing camera associated with the vehicle in order to predict a trajectory of the object, wherein the generating of the alert is further based on the predicting of the trajectory of the object.

In certain embodiments, the determining of the driver intent to move the vehicle in the given direction is based on one or more of: activation of a turn signal of the vehicle; or the route data for the vehicle.

In some embodiments, the generating of the alert comprises generating a graphical indicator of the object for display via a screen within the vehicle.

FIG. 7 depicts an example display screen 700 associated with blind spot object tracking, in accordance with embodiments of the present disclosure. For example, display screen 700 may be an example of a display screen shown on a front display 104 of FIG. 1A and/or a user interface 200 of FIG. 2 and/or an instrument panel of vehicle 100 of FIG. 1A, and includes a right side blind spot view. For example, display screen 700 may comprise an alert related to a detected object as described above, such as being displayed in response to a determination that a detected object is predicted to be in or near a location to which the vehicle is predicted to move (e.g., as a result of a predicted and/or signaled lane change).

Display screen 700 includes a camera view 710 that includes a live feed from a right-side rear-facing camera of the vehicle (e.g., one of cameras 102 of FIG. 1A). For example, a determination may have been made to display camera view 710 based on determining that the vehicle is likely to move one or more lanes to the right (e.g., based on the driver activating a right turn signal and/or based on vehicle data and/or route data).

Display screen 700 further includes a graphical depiction 702 of the vehicle and a graphical depiction 706 of a detected object (in this case a motorcycle) that is located to the right side and slightly behind the vehicle (e.g., in the driver's right-side blind spot). Graphical indicator 704 may be displayed to alert the driver to the presence of the object represented by graphical depiction 706, such as including particular color(s) (e.g., red), shape(s) (e.g., arcs), movement (e.g., blinking), and/or the like, such as being displayed proximate to graphical depiction 706 of the detected object in display screen 700. For example, graphical indicator 704 may be displayed based on an automated determination (e.g., using one or more techniques described above) that the detected object represented by graphical depiction 706 is now or is likely to soon be located in or within a threshold distance of a location to which the vehicle is predicted to move (e.g., one lane to the right).

FIG. 8 depicts another example display screen 800 associated with blind spot object tracking, in accordance with embodiments of the present disclosure. For example, display screen 780 may be an example of a display screen shown on a front display 104 of FIG. 1A and/or a user interface 200 of FIG. 2 and/or an instrument panel of vehicle 100 of FIG. 1A, and includes a left side blind spot view. For example, display screen 800 may comprise an alert related to a detected object as described above, such as being displayed in response to a determination that a detected object is predicted to be in or near a location to which the vehicle is predicted to move (e.g., as a result of a predicted and/or signaled lane change).

Display screen 800 includes a camera view 810 that includes a live feed from a left-side rear-facing camera of the vehicle (e.g., one of cameras 102 of FIG. 1A). For example, a determination may have been made to display camera view 810 based on determining that the vehicle is likely to move one or more lanes to the left (e.g., based on the driver activating a left turn signal and/or based on vehicle data and/or route data).

Display screen 800 further includes a graphical depiction 802 of the vehicle and a graphical depiction 806 of a detected object (in this case a different vehicle) that is located to the left side and slightly behind the vehicle (e.g., in the driver's left-side blind spot). Graphical indicator 804 may be displayed to alert the driver to the presence of the object represented by graphical depiction 806, such as including particular color(s) (e.g., red), shape(s) (e.g., arcs), movement (e.g., blinking), and/or the like, such as being displayed proximate to graphical depiction 806 of the detected object in display screen 800. For example, graphical indicator 804 may be displayed based on an automated determination (e.g., using one or more techniques described above) that the detected object represented by graphical depiction 806 is now or is likely to soon be located in or within a threshold distance of a location to which the vehicle is predicted to move (e.g., one lane to the left).

The display screens depicted in FIGS. 7 and 8 are included as examples, and many other types of display screens and/or other forms of alerts may be used according to techniques described herein to alert a driver to the presence of a detected object in a given direction, such as one lane to the left or right of the vehicle.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method for vehicle blind spot object tracking, comprising:
performing object detection using a machine learning model based on video data captured by one or more cameras associated with a vehicle in order to detect an object;
predicting an intent associated with the object based on one or more features associated with the object in the video data;
applying a collision prediction algorithm based on the object, the intent associated with the object, and one or more measured attributes of the vehicle, in order to predict a proximity between the vehicle and the object in a given direction; and
generating, after determining an intent to move the vehicle in the given direction, an alert for presentation within the vehicle based on the predicted proximity between the vehicle and the object.

2. The method of claim 1, wherein the applying of the collision prediction algorithm is further based on route data for the vehicle, and wherein route data for the vehicle is based on a configured route associated with a satellite-based navigation system.

3. The method of claim 1, further comprising:
estimating a distance and a trajectory associated with the object relative to the vehicle based on performing multiple object tracking (MOT) using a computer vision technique after the detecting of the object, wherein the applying of the collision prediction algorithm is based on the distance and the trajectory.

4. The method of claim 3, wherein the one or more measured attributes comprises one or more of a speed of the vehicle, a steering wheel angle of the vehicle, or a heading of the vehicle.

5. The method of claim 4, wherein the applying of the collision prediction algorithm is further based on performing an optical flow, block matching, or Kalman filtering technique with respect to the video data to monitor movement of the object.

6. The method of claim 1, further comprising:
providing a sliding window of frames from the video data as inputs to a convolutional neural network (CNN) and a recurrent neural network (RNN) to detect one or more traffic lanes;
extracting a segmentation mask of the object from the frames; and
comparing boundaries of the one or more traffic lanes to the segmentation mask of the object to predict whether the object is in an adjacent lane to the vehicle, wherein the generating of the alert is further based on the predicting of whether the object is in the adjacent lane to the vehicle.

7. The method of claim 6, wherein the comparing of the boundaries of the one or more traffic lanes to the segmentation mask of the object comprises computing an intersection over union (IoU) of the boundaries of the one or more traffic lanes to the segmentation mask of the object and comparing the IoU to a threshold.

8. The method of claim 1, further comprising analyzing data captured using a rear-facing camera associated with the vehicle in order to predict a trajectory of the object, wherein the generating of the alert is further based on the predicting of the trajectory of the object.

9. The method of claim 1, wherein the determining of the intent to move the vehicle in the given direction is based on one or more of:
activation of a turn signal of the vehicle; or
route data for the vehicle.

10. The method of claim 1, wherein the generating of the alert comprises generating a graphical indicator of the object for display via a screen within the vehicle.

11. A vehicle comprising:
one or more cameras;
a display within an interior of the vehicle;
one or more processors; and
a memory storing instructions that, when executed by the one or more processors, cause the one or more processors to:
perform object detection using a machine learning model based on video data captured by the one or more cameras in order to detect an object;
predict an intent associated with the object based on one or more features associated with the object in the video data;
apply a collision prediction algorithm based on the object, the intent associated with the object, and one or more measured attributes of the vehicle, in order to predict a proximity between the vehicle and the object in a given direction; and
generate, after determining an intent to move the vehicle in the given direction, an alert for presentation via the display based on the predicted proximity between the vehicle and the object.

12. The vehicle of claim 11, wherein the applying of the collision prediction algorithm is further based on route data for the vehicle, and wherein route data for the vehicle is based on a configured route associated with a satellite-based navigation system.

13. The vehicle of claim 11, wherein the instructions, when executed by the one or more processors, further cause the one or more processors to:
estimate a distance and a trajectory associated with the object relative to the vehicle based on performing multiple object tracking (MOT) using a computer vision technique after the detecting of the object, wherein the applying of the collision prediction algorithm is based on the distance and the trajectory.

14. The vehicle of claim 13, wherein the one or more measured attributes comprises one or more of a speed of the vehicle, a steering wheel angle of the vehicle, or a heading of the vehicle.

15. The vehicle of claim 14, wherein the applying of the collision prediction algorithm is further based on performing an optical flow, block matching, or Kalman filtering technique with respect to the video data to monitor movement of the object.

16. The vehicle of claim 11, wherein the instructions, when executed by the one or more processors, further cause the one or more processors to:
provide a sliding window of frames from the video data as inputs to a convolutional neural network (CNN) and a recurrent neural network (RNN) to detect one or more traffic lanes;
extract a segmentation mask of the object from the frames; and
compare boundaries of the one or more traffic lanes to the segmentation mask of the object to predict whether the object is in an adjacent lane to the vehicle, wherein the generating of the alert is further based on the predicting of whether the object is in the adjacent lane to the vehicle.

17. The vehicle of claim 16, wherein the comparing of the boundaries of the one or more traffic lanes to the segmentation mask of the object comprises computing an intersection over union (IoU) of the boundaries of the one or more traffic lanes to the segmentation mask of the object and comparing the IoU to a threshold.

18. The vehicle of claim 11, wherein the instructions, when executed by the one or more processors, further cause the one or more processors to analyze data captured using a rear-facing camera associated with the vehicle in order to predict a trajectory of the object, wherein the generating of the alert is further based on the predicting of the trajectory of the object.

19. The vehicle of claim 11, wherein the determining of the intent to move the vehicle in the given direction is based on one or more of:
activation of a turn signal of the vehicle; or
route data for the vehicle.

20. A non-transitory computer readable medium comprising instructions that, when executed by one or more processors of a computing system, cause the computing system to:
perform object detection using a machine learning model based on video data captured by one or more cameras associated with a vehicle in order to detect an object;
predict an intent associated with the object based on one or more features associated with the object in the video data;
apply a collision prediction algorithm based on the object, the intent associated with the object, and one or more measured attributes of the vehicle, in order to predict a proximity between the vehicle and the object in a given direction; and
generate, after determining an intent to move the vehicle in the given direction, an alert for presentation within the vehicle based on the predicted proximity between the vehicle and the object.
